(19) United States
(12) Patent Application Publication
(10) Pub. No.: US 2014/0170422 A1
(43) Pub. Date: Jun. 19, 2014

(54) Low emissivity coating with optimal base layer material and layer stack

(71) Applicant: INTERMOLECULAR INC., San Jose, CA (US)

(72) Inventors: Yu Wang, San Jose, CA (US); Brent Boyce, Novi, MI (US); Guowen Ding, San Jose, CA (US); Mohd Fadzli Anwar Hassan, San Francisco, CA (US); Minh Huu Le, San Jose, CA (US); Haifan Liang, Fremont, CA (US); Zhi-Wen Wen Sun, Sunnyvale, CA (US)

(73) Assignee: INTERMOLECULAR INC., San Jose, CA (US)

(21) Appl. No.: 13/715,588

(22) Filed: Dec. 14, 2012

(51) Int. Cl. G02B 1/10

(52) U.S. Cl. CPC G02B 1/10
USPC 428/432; 427/160; 427/162; 428/469

(57) ABSTRACT

A method for making low emissivity panels, including forming a base layer to promote a seed layer for a conductive silver layer. The base layer can be an amorphous layer or a nanocrystalline layer, which can facilitate zinc oxide seed layer growth, together with smoother surface and improved thermal stability. The base layer can include doped tin oxide, for example, tin oxide doped with Al, Ga, In, Mg, Ca, Sr, Sb, Bi, Ti, V, Y, Zr, Nb, Hf, Ta, or any combination thereof. The doped tin oxide base layer can influence the growth of (002) crystallographic orientation in zinc oxide, which in turn serves as a seed layer template for silver (111).

### FIELD OF THE INVENTION

The present invention relates generally to films providing high transmittance and low emissivity, and more particularly to such films deposited on transparent substrates.

### BACKGROUND OF THE INVENTION

Sunlight control glasses are commonly used in applications such as building glass windows and vehicle windows, typically offering high visible transmission and low emissivity. High visible transmission can allow more sunlight to pass through the glass windows, thus being desirable in many window applications. Low emissivity can block infrared (IR) radiation to reduce undesirable interior heating.

In low emissivity glasses, IR radiation is mostly reflected with minimum absorption and emission, thus reducing the heat transferring to and from the low emissivity surface. Low emissivity, or low-e, panels are often formed by depositing a reflective layer (e.g., silver) onto a substrate, such as glass. The overall quality of the reflective layer, such as with respect to texturing and crystallographic orientation, is important for achieving the desired performance, such as high visible light transmission and low emissivity (i.e., high heat reflection). In order to provide adhesion, as well as protection, several other layers are typically formed both under and over the reflective layer. The various layers typically include dielectric layers, such as silicon nitride, tin oxide, and zinc oxide, to provide a barrier between the stack and both the substrate and the environment, as well as to act as optical fillers and function as anti-reflective coating layers to improve the optical characteristics of the panel.

The overall quality of the reflective layer, for example, its crystallographic orientation, is important for achieving the desired performance, such as high visible light transmission and low emissivity (i.e., high heat reflection). One known method to achieve low emissivity is to form a relatively thick silver layer. However, as the thickness of the silver layer increases, the visible light transmission of the reflective layer is reduced, as is manufacturing throughput, while overall manufacturing costs are increased. Therefore, is it desirable to form the silver layer as thin as possible, while still providing emissivity that is suitable for low-e applications.

### SUMMARY

A conductive layer can exhibit infrared reflectance behavior, with the percentage of reflectance proportional to the conductivity. The conductivity of a material can depend on its crystallographic orientation, for example, (111) silver has lowest conductivity. To promote a desired crystallographic orientation of a deposited material, a seed layer can be used to provide a template. For example, to promote deposition of (111) silver layer, zinc oxide having (002) crystallographic orientation can be used as a seed layer. A layer below the seed layer, called a base layer, can also have influence on the silver quality, for example, due to the influence on the seed layer.

In some embodiments, methods to form a base layer for a zinc oxide seed layer are provided which can allow forming a silver layer with improved quality. The base layer can be an amorphous layer or a nanocrystalline layer, which can facilitate zinc oxide seed layer growth, together with smoother surface and improved thermal stability. Amorphous base layer can include materials without any long range order. Nanocrystalline base layer can include polycrystalline materials with a crystallite size of only a few nanometers. The crystallite size of the nanocrystalline base layer can be between 0.5 nm and 5 nm.

X-ray diffraction can be used to determine the crystallinity, e.g., amorphous, nanocrystalline or crystalline, of the base layer. In amorphous base layer, X-ray diffraction pattern shows no discernible crystallinity peaks. In nanocrystalline base layer, X-ray diffraction pattern can indicate the presence of crystallinity peaks, but the crystallinity peaks can be too wide to allow determination of the crystal structure.

In some embodiments, base layers are provided for a zinc oxide or doped zinc oxide seed layers for a silver reflective layer to be used in low emissivity coatings. The base layer can include doped tin oxide, for example, tin oxide doped with Al, Ga, In, Mg, Ca, Sr, Sb, Bi, Ti, V, Y, Zr, Nb, Hf, Ta, or any combination thereof. The doped tin oxide base layer can influence the growth of (002) crystallographic orientation in zinc oxide, which in turn serves as a seed layer template for silver (111).

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1A illustrates a thin film coating according to some embodiments.

FIG. 1B illustrates a low emissivity transparent panel according to some embodiments.

FIGS. 2A-2B illustrate physical vapor deposition (PVD) systems according to some embodiments.

FIG. 3 illustrates an in-line deposition system according to some embodiments.

FIG. 4 illustrates a flow chart for sputtering coated layers according to some embodiments.

FIG. 5 illustrates a flow chart for sputtering coated layers according to some embodiments.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

In some embodiments, methods and apparatuses for making coated panels are disclosed. The coated panels can include coated layers formed thereon, such as a low resistivity thin infrared reflective layer having a conductive material such as silver. The infrared reflective layer can include a conductive material, with the percentage of reflectance proportional to the conductivity. Thus a metallic layer, for example silver, can be used as infrared reflective layer in low emissivity coatings. To improve the quality, e.g., conductivity of the infrared reflective layer, such as a silver layer, a base layer that can be configured to improve a seed layer, which can serve as a template for forming the silver layer.

In some embodiments, provided are methods, and coated panels fabricated from the methods, for forming a low-e panel with improved overall quality of an infrared reflective layer (such as silver, gold or copper). The methods can include forming a base layer for a zinc oxide or doped zinc oxide layer, which then can be used as a seed layer for the infrared reflective layer.

In some embodiments, methods and apparatuses for making low emissivity coated panels, which include depositing an amorphous or nanocrystalline base layer having doped tin oxide before depositing a seed layer and a subsequent silver layer. The base layer can provide improvement to the silver quality, for example, optimizing the resistivity of silver, and consequently the emissivity of the coated panels. For example, the base layer can include tin oxide doped with Al, Ga, In, Mg, Ca, Sr, Sb, Bi, Ti, V, Y, Zr, Nb, Hf, Ta, or any combination thereof.

In some embodiments, methods and apparatuses for making low emissivity panels are provided, which include forming a base layer for a silver infrared reflective layer. The base layer can reduce the amount of agglomeration during the silver layer formation, promoting a better (111) texture, e.g., smoothness, for better quality silver. High quality silver layer can provide better electrical property, leading to thinner thickness of silver layer and better visible light transmission.

Generally, it is preferable to form the infrared reflective layer in such a way that visible light transmission is high and emissivity is low. It is also preferable to maximize volume production, throughput, and efficiency of the manufacturing process used to form low-e panels. Thus a seed layer can be used to promote a preferred crystallography orientation of silver, leading to high silver conductivity.

For example, with a silver infrared reflective layer, it can be preferably for the silver layer to have (111) crystallographic orientation because it allows for the silver layer to have relatively high electrical conductivity, and thus relatively low sheet resistance (Rs) at thin layer thickness. Thin layer thickness is desirable to provide high visible light transmission, and low sheet resistance is preferred low sheet resistance can offer low infrared emissivity.

To promote the crystal orientation of the infrared reflective layer, a seed layer can be used. Generally, seed layers are relatively thin layers of materials formed on a surface (e.g., a substrate) to promote a particular characteristic of a subsequent layer formed over the surface (e.g., on the seed layer). For example, seed layers may be used to improve adhesion between the subsequent layer and the substrate or increase the rate at which the subsequent layer is grown on the substrate during the respective deposition process.

A seed layer can also affect the crystalline structure (or crystallographic orientation) of the subsequent layer, which is sometimes referred to as “templating.” For example, the interaction of the material of the subsequent layer with the crystalline structure of the seed layer causes the crystalline structure of the subsequent layer to be formed in a particular orientation.

For example, a seed layer can be used to promote growth of the infrared reflective layer in a particular crystallographic orientation. For example, a seed layer can comprise a material with a hexagonal crystal structure and can be formed with a (002) crystallographic orientation (such as zinc oxide or doped zinc oxide), which promotes growth of a silver layer in the (111) orientation when the silver layer has a face centered cubic crystal. Thus the seed layer can improve the conductivity of the deposited silver layer such that the thickness of the silver layer may be reduced while still providing the desirably low emissivity. In some embodiments, the formation of a high conductivity and thin silver layer can be achieved by forming a relatively thin (e.g., up to about 5 nm) seed layer of, for example, zinc oxide or doped zinc oxide on the substrate, before depositing the silver layer.

In some embodiments, methods, and coated panels formed for the methods, are provided that can improve a zinc oxide containing seed layer, which in turn, can improve an infrared reflective layer, e.g., a silver layer. In some embodiments, methods are provided to form zinc oxide or doped zinc oxide layers having large grain sizes with preferred crystal orientation. For example, (002) oriented zinc oxide or doped zinc oxide layers can be formed on an amorphous or nanocrystalline base layer of doped tine oxide to enhance the conductivity of a subsequently deposited silver layer. The dopants can include Mg, or other elements such as Al, Ga, In, Ca, Sr, Sb, Bi, Ti, V, Y, Zr, Nb, Hf, or Ta. In some embodiments, the thin silver layer can be thinner than 10 nm, such as 7 or 8 nm, while still providing desirably low emissivity.

The coated transparent panels can include a glass substrate or any other transparent substrates, such as substrates made of organic polymers. The coated transparent panels can be used in window applications such as vehicle and building windows, skylights, or glass doors, either in monolithic glazings or multiple glazings with or without a plastic interlayer or a gas-filled sealed interspace.

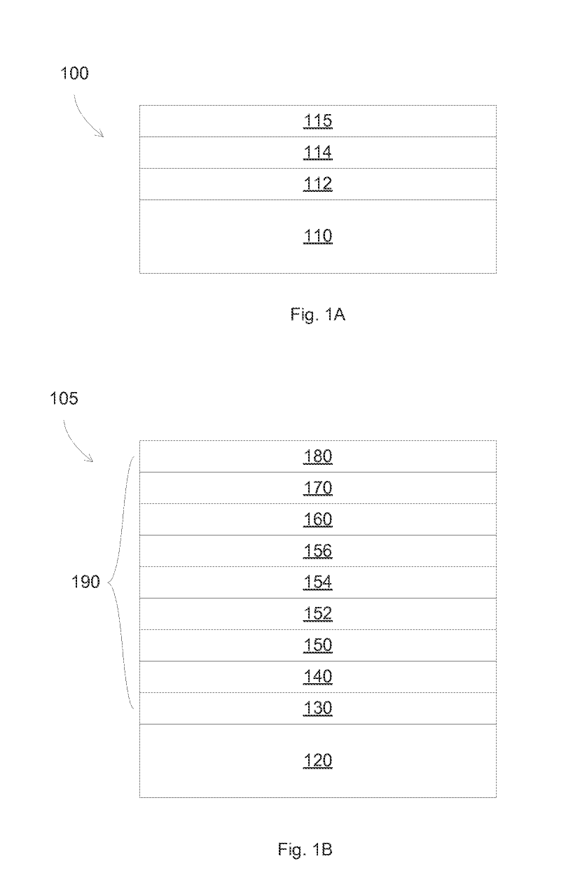

FIG. 1A illustrates a thin film coating according to some embodiments. An infrared reflective layer, such as a silver layer 115, is disposed on a seed layer, such as a zinc oxide or a doped zinc oxide layer 114, which is disposed on a base layer 112 on a substrate 110 to form a coated transparent panel 100, which has high visible light transmission, and low IR emission. The seed layer 114 can have (002) crystal orientation to promote a (111) crystal orientation of the silver layer 115. The base layer 112 can include materials and/or crystal orientation to promote the (002) crystal orientation of the zinc oxide or doped zinc oxide layer 114. In some embodiments, the base layer can include doped tin oxide, such as magnesium doped tin oxide. Other dopants can be used, such as Al, Ga, In, Ca, Sr, Sb, Bi, Ti, V, Y, Zr, Nb, Hf, or Ta. The base layer can also be amorphous or nanocrystalline, e.g., without any long range order of the crystal structure.

The layers 112, 114, and/or 115 can be sputter deposited using different processes and equipment, for example, the targets can be sputtered under direct current (DC), pulsed DC, alternate current (AC), radio frequency (RF) or any other suitable conditions. In some embodiments, the present invention discloses a physical vapor deposition method for depositing the layers 112, 114, and/or 115. The deposition process can comprise a gas mixture introduced to a plasma ambient to sputter material from one or more targets disposed in the processing chamber. The sputtering process can further comprise other components such as magnets for confining the plasma, and utilize different process conditions such as DC, AC, RF, or pulse sputtering.

In some embodiments, a coating stack can be provided, including multiple layers for different functional purposes. For example, the coating stack can include a seed layer to facilitate the deposition of the reflective layer, and a base layer to facilitate the deposition of the seed layer. Other layers can be added, such as an oxygen diffusion barrier layer disposed on the reflective layer to prevent oxidation of the reflective layer, a protective layer disposed on the substrate to prevent physical or chemical abrasion, or an antireflective layer to reduce visible light reflection. The coating stack can include multiple layers of reflective layers to improve IR emissivity.

FIG. 1B illustrates a low emissivity transparent panel 105 according to some embodiments. The low emissivity transparent panel can include a glass substrate 120 and a low-e stack 190 formed over the glass substrate 120. The glass substrate 120 in some embodiments can be made of a glass, such as borosilicate glass, and has a thickness of, for example, between 1 and 10 millimeters (mm). The substrate 120 may be square or rectangular and about 0.5-2 meters (m) across. In some embodiments, the substrate 120 may be made of, for example, plastic or polycarbonate.

The low-e stack 190 includes a lower protective layer 130, a lower oxide layer 140, a base layer 150, a seed layer 152, a reflective layer 154, a barrier layer 156, an upper oxide 160, an optical filler layer 170, and an upper protective layer 180. Some layers can be optional, and other layers can be added, such as interface layer or adhesion layer. Exemplary details as to the functionality provided by each of the layers 130-180 are provided below.

The various layers in the low-e stack 190 may be formed sequentially (i.e., from bottom to top) on the glass substrate 120 using a physical vapor deposition (PVD) and/or reactive (or plasma enhanced) sputtering processing tool. In some embodiments, the low-e stack 190 is formed over the entire glass substrate 120. However, in other embodiments, the low-e stack 190 may only be formed on isolated portions of the glass substrate 120.

The lower protective layer 130 is formed on the upper surface of the glass substrate 120. The lower protective layer 130 can include silicon nitride, silicon oxynitride, or other nitride material such as SiZrN, for example, to protect the other layers in the stack 190 from diffusion from the substrate 120 or to improve the haze reduction properties. In some embodiments, the lower protective layer 130 is made of silicon nitride and has a thickness of, for example, between about 10 nm to 50 nm, such as 25 nm.

The lower oxide layer 140 is formed on the lower protective layer 130 and over the glass substrate 120. The lower oxide layer 140 can be a metal oxide or metal alloy oxide layer and can serve as an antireflective layer.

The seed layer 152 can act as template layer for the IR reflective film, for example, a zinc oxide layer deposited before the deposition of a silver reflective layer can provide a silver layer with a preferred crystallographic orientation, which can lead to lower resistivity, improving its reflective characteristics. The seed layer can include zinc oxide or doped zinc oxide. In some embodiments, the seed layer can include other crystalline metal oxide such as SnO₂, Sc₂O₃, Y₂O₃, TiO₂, ZrO₂, HfO₂, V₂O₅, Nb₂O₅, Ta₂O₅, Cro₃, WO₃, or MoO₃.

In some embodiments, the seed layer 152 can be continuous and covers the entire substrate. For example, the thickness of the seed layer can be less than about 100 Angstroms, and preferably less than about 50 Angstroms. Alternatively, the seed layer 152 may not be formed in a completely continuous manner. The seed layer can be distributed across the substrate surface such that each of the seed layer areas is laterally spaced apart from the other seed layer areas across the substrate surface and do not completely cover the substrate surface. For example, the thickness of the seed layer 152 can be a monolayer or less, such as between 2.0 and 4.0 Å, and the separation between the layer sections may be the result of forming such a thin seed layer (i.e., such a thin layer may not form a continuous layer).

The reflective layer 154 is formed on the seed layer 152. The IR reflective layer can be a metallic, reflective film, such as gold, copper, or silver. In general, the IR reflective film includes a good electrical conductor, blocking the passage of thermal energy. In some embodiments, the reflective layer 154 is made of silver and has a thickness of, for example, 100 Å. Because the reflective layer 154 is formed on the seed layer 152, for example, due to the (002) crystallographic orientation of the seed layer 152, growth of the silver reflective layer 154 in a (111) crystalline orientation is promoted, which offers low sheet resistance, leading to low panel emissivity.

Because of the promoted (111) texturing orientation of the reflective layer 154 caused by the seed layer 152, the conductivity and emissivity of the reflective layer 154 is improved. As a result, a thinner reflective layer 154 may be formed that still provides sufficient reflective properties and visible light transmission. Additionally, the reduced thickness of the reflective layer 154 allows for less material to be used in each panel that is manufactured, thus improving manufacturing throughput and efficiency, increasing the usable life of the target (e.g., silver) used to form the reflective layer 154, and reducing overall manufacturing costs.

In some embodiments, the crystallographic orientation can be characterized by X-ray diffraction (XRD) technique, which is based on observing the scattered intensity of an X-ray beam hitting the layer, e.g., silver layer or seed layer, as a function of the X-ray characteristics, such as the incident and scattered angles. For example, zinc oxide seed layer can show a pronounced (002) peak and higher orders in a θ-2θ diffraction pattern. This suggests that zinc oxide crystallites with the respective planes oriented parallel to the substrate surface are present.

In some embodiments, the terms “silver layer having (111) crystallographic orientation”, or “zinc oxide seed layer having (002) crystallographic orientation” include a meaning that there is a (111) preferred crystallographic orientation for the silver layer or a (002) preferred crystallographic orientation for the zinc oxide seed layer, respectively. The preferred crystallographic orientation can be determined, for example, by observing pronounced crystallography peaks in an XRD characterization.

In some embodiments, a base layer 150 is provided, which can serve as a seed layer for the ZnO seed layer 152. The base layer 150 can further improve the ZnO film crystallinity and the preferred crystal orientation for the (002) basal plane to optimize the optical and electrical properties of the second ZnO seed layer 152. In some embodiments, methods are provided to improve the seed layer (e.g., the seed layer for the infrared reflective layer) by providing a promotion layer, e.g. a base layer to promote the film crystallinity and the crystal orientation of the seed layer.

In some embodiments, the base layer can include amorphous or nanocrystalline materials, such as a doped tin oxide. Tin oxide can be crystalline, and doped tin oxide can destroy the crystallinity of tin oxide, forming an amorphous or nanocrystalline base layer. The dopants of the base layer can include Al, Ga, In, Mg, Ca, Sr, Sb, Bi, Ti, V, Y, Zr, Nb, Hf, or Ta. For example, as compared to tin oxide, 10 vol % Mg doped tin oxide base layer can improve the smoothness of a 45 nm silver layer by more than 50%. In some embodiments, the dopants can be between 1 and 15 vol %, such as between 3 and 13 vol %.

In some embodiments, the base layer can have similar characteristics as those of the seed layer. For example, the base layer can be continuous and covers the entire substrate, with thickness less than about 45 nm, or less than about 20 nm. In some embodiments, the thickness of the base layer can be less than about 10 nm. Alternatively, the base layer may not be formed in a completely continuous manner. The thickness of the base layer can be a monolayer or less, such as between 0.2 and 0.4 nm.

Because of the promoted (111) crystal orientation of the reflective layer 154, which is caused by the promoted (002) crystal orientation of the seed layer 152, which, in turn, is caused by the base layer 150, the conductivity and emissivity of the reflective layer 154 is improved. As a result, a thinner reflective layer 154 may be formed that still provides sufficient reflective properties and visible light transmission. Additionally, the reduced thickness of the reflective layer 154 allows for less material to be used in each panel that is manufactured, thus improving manufacturing throughput and efficiency, increasing the usable life of the target (e.g., silver) used to form the reflective layer 154, and reducing overall manufacturing costs.

Further, the seed layer 152 or the base layer 150 can provide a barrier between the metal oxide layer 140 and the reflective layer 154 to reduce the likelihood of any reaction of the material of the reflective layer 154 and the oxygen in the lower metal oxide layer 140, especially during subsequent heating processes. As a result, the resistivity of the reflective layer 154 may be reduced, thus increasing performance of the reflective layer 154 by lowering the emissivity.

Formed on the reflective layer 154 is a barrier layer 156, which can protect the reflective layer 154 from being oxidized. For example, the barrier layer can be a diffusion barrier, stopping oxygen from diffusing into the silver layer from the upper oxide layer 160. The barrier layer 156 can include titanium, nickel, chromium, or a combination of nickel, titanium, and chromium, such as NiCr or NiTi.

Formed on the barrier layer 156 is an upper oxide layer 160, which can function as an antireflective film stack, including a single layer or multiple layers for different functional purposes. The antireflective layer 160 serves to reduce the reflection of visible light, selected based on transmittance, index of refraction, adherence, chemical durability, and thermal stability. In some embodiments, the antireflective layer 160 includes tin oxide, offering high thermal stability properties. The antireflective layer 160 can include titanium dioxide, silicon nitride, silicon dioxide, silicon oxynitride, niobium oxide, SiZrN, tin oxide, zinc oxide, or any other suitable dielectric material.

Formed on the antireflective layer 160 is an optical filler layer 170. The optical filler layer 170 can be used to provide a proper thickness to the low-e stack, for example, to provide an antireflective property. The optical filler layer preferably has high visible light transmittance. In some embodiments, the optical filler layer 170 is made of tin oxide and has a thickness of, for example, 100 Å. The optical filler layer may be used to tune the optical properties of the low-e panel 105. For example, the thickness and refractive index of the optical filler layer may be used to increase the layer thickness to a multiple of the incoming light wavelengths, effectively reducing the light reflectance and improving the light transmittance.

Formed on the optical filler layer 170 is an upper protective layer 180. An upper protective layer 180 can be used for protecting the total film stack, for example, to protect the panel from physical or chemical abrasion. The upper protective layer 180 can be an exterior protective layer, such as silicon nitride, silicon oxynitride, titanium oxide, tin oxide, zinc oxide, niobium oxide, or SiZrN.

In some embodiments, adhesion layers can be used to provide adhesion between layers. The adhesion layers can be made of a metal alloy, such as nickel-titanium, and have a thickness of, for example, 30 Å.

Depending on the materials used, some of the layers of the low-e stack 190 may have some elements in common. An example of such a stack may use a zinc-based material in the oxide dielectric layers 140 and 160. As a result, a relatively low number of different targets can be used for the formation of the low-e stack 190.

In some embodiments, the coating can include a double or triple layer stack, having multiple IR reflective layers. In some embodiments, the layers can be formed using a plasma enhanced, or reactive sputtering, in which a carrier gas (e.g., argon) is used to eject ions from a target, which then pass through a mixture of the carrier gas and a reactive gas (e.g., oxygen), or plasma, before being deposited.

In some embodiments, sputter deposition processes, which can be applied for a base layer deposited before a conductive layer are provided. For example, the base layer can improve the smoothness of the infrared reflective layer.

In some embodiments, the doped base layer can be sputtered from an alloyed target, or co-sputtered from different elemental targets onto the same substrate. The process may be in pure Ar, or may include oxygen to make the film oxidized.

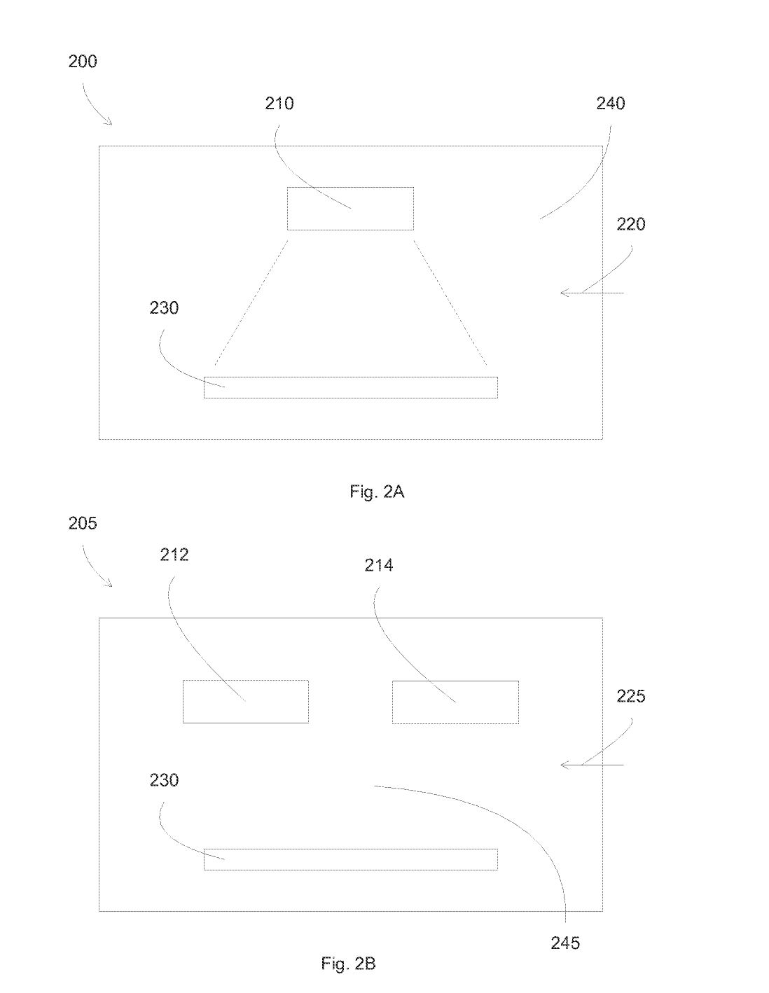

FIGS. 2A-2B illustrate physical vapor deposition (PVD) systems according to some embodiments. In FIG. 2A, a PVD system, also commonly called sputter system or sputter deposition system, 200 includes a housing that defines, or encloses, a processing chamber 240, a substrate 230, a target assembly 210, and reactive species delivered from an outside source 220. The substrate can be stationary, or in some manufacturing environments, the substrate may be in motion during the deposition processes. During deposition, the target is bombarded with argon ions, which releases sputtered particles toward the substrate 230. The sputter system 200 can perform blanket deposition on the substrate 230, forming a deposited layer that cover the whole substrate, e.g., the area of the substrate that can be reached by the sputtered particles generated from the target assembly 210.

In FIG. 2B, a sputter deposition chamber 205 includes two target assemblies 210A and 210B disposed in the processing chamber 240, containing reactive species delivered from an outside source 220. The target assemblies 210A and 210B can include the dopant and silver to deposit a doped silver layer on substrate 230. This configuration is exemplary, and other sputter system configurations can be used, such as a single target as above, including and alloy of dopant and silver.

The materials used in the target assembly 210 (FIG. 2A) may, for example, include Ag, Ti, Si, Pd, Cr, Ni, Zr, Mn, Fe, Ta, Pt, Zn, Sn, Mg, Al, La, Y, Sb, Sr, Bi, Al, Ga, In, Ca, V, Nb, Hf, or any combination thereof (i.e., a single target may be made of an alloy of several metals). Additionally, the materials used in the targets may include oxygen, nitrogen, or a combination of oxygen and nitrogen in order to form the oxides, nitrides, and oxynitrides described above. Additionally, although only one target assembly 210 is shown (FIG. 2A), additional target assemblies may be used (e.g. FIG. 2B). As such, different combinations of targets may be used to form, for example, the dielectric layers described above. For example, in some embodiments in which the dielectric material is zinc-tin-titanium oxide, the zinc, the tin, and the titanium may be provided by separate zinc, tin, and titanium targets, or they may be provided by a single zinc-tin-titanium alloy target. For example, the target assembly 210 can include a silver target, and together with argon ions, sputter deposit a silver layer on substrate 230. The target assembly 210 can include a metal or metal alloy target, such as Ag, Ti, or Ti—Ag alloy, to sputter deposit silver or doped silver layers.

The sputter deposition system 200 can include other components, such as a substrate support for supporting the substrate. The substrate support can include a vacuum chuck, electrostatic chuck, or other known mechanisms. The substrate support can be capable of rotating around an axis thereof that is perpendicular to the surface of the substrate. In addition, the substrate support may move in a vertical direction or in a planar direction. It should be appreciated that the rotation and movement in the vertical direction or planar direction may be achieved through known drive mechanisms which include magnetic drives, linear drives, worm screws, lead screws, a differentially pumped rotary feed through drive, etc.

In some embodiments, the substrate support includes an electrode which is connected to a power supply, for example, to provide a RF or dc bias to the substrate, or to provide a plasma environment in the process housing 240. The target assembly 210 can include an electrode which is connected to a power supply to generate a plasma in the process housing. The target assembly 210 is preferably oriented towards the substrate 230.

The sputter deposition system 200 can also include a power supply coupled to the target electrode. The power supply provides power to the electrodes, causing material to be, at least in some embodiments, sputtered from the target. During sputtering, inert gases, such as argon or krypton, may be introduced into the processing chamber 240 through the gas inlet 220. In embodiments in which reactive sputtering is used, reactive gases may also be introduced, such as oxygen and/or nitrogen, which interact with particles ejected from the targets to form oxides, nitrides, and/or oxynitrides on the substrate.

The sputter deposition system 200 can also include a control system (not shown) having, for example, a processor and a memory, which is in operable communication with the other components and configured to control the operation thereof in order to perform the methods described herein.

In some embodiments, the present invention discloses methods to form low-e panels, including forming a base layer for a seed layer, wherein the seed layer can be used as a seed layer for an infrared reflective layer. In some embodiments, a transparent substrate is provided. A base layer is formed over the transparent substrate. The base layer includes a tin oxide doped with a dopant to form an amorphous or nanocrystalline doped tin oxide structure. A seed layer is formed over the base layer. The seed layer includes zinc oxide or doped zinc oxide material. The seed layer preferably includes (002) crystal orientation. For example, more than about 30% of the seed layer has a (002) crystallographic orientation. A silver layer is formed on the seed layer. The silver layer preferably includes (111) crystal orientation.

In some embodiments, the base layer can improve the crystallinity and (002) orientation of the zinc oxide or doped zinc oxide layer. The improvement of the zinc oxide or doped zinc oxide layer can in turn improve the (111) silver growing on top of the zinc oxide or doped zinc oxide layer, producing a silver layer with improved electrical conductivity. The methods thus can maximize volume production, throughput, and efficiency of the manufacturing process used to form low emissivity panels.

For example, using a layer stack including a 8 nm silver layer on a 10 nm ZnO seed layer on a 45 nm base layer, the roughness of the layer stack can be measured, e.g., by an atomic force microscope (AFM) to compare the effect of different base layers. A tin oxide base layer, which can be crystalline, can lead to about 1.92 nm roughness, as measured as a root means square (RMS) of the surface variation of the silver layer. This roughness is significantly larger, more than double the roughness of an amorphous base layer of 7.5 vol % Mg doped tin oxide (0.76 nm) or 10.5 vol % Mg doped tin oxide (0.87 nm). In other words, Mg doped tin oxide, at less than 15 vol % doping, can provide better than 50 improvement over tin oxide. The improvement can be partially attributed to the microstructure of the base layer, since the Mg doped tin oxide can exhibit an amorphous or nanocrystalline structure, e.g., with grain size less than 5 nm, as compared to a crystalline structure of tin oxide. Other dopant can be used with different degrees of improvement. For example, 6.5 vol % Al doped tin oxide can show about 1.4 nm roughness, or 12.5 vol % Al doped tin oxide can show about 1.7 nm roughness.

In some embodiments, a base layer including a doped tin oxide layer is formed before forming a seed layer such as a zinc oxide layer. The base can serve as a template, e.g., a seed layer, for the formation of the zinc oxide layer. For example, the amorphous nature of the doped tin oxide base layer can serve to promote forming a zinc oxide layer with a desired crystalline structure. In the present description, the term “zinc oxide layer” means “a layer including zinc oxide material”, thus includes zinc oxide layers and doped zinc oxide layers.

In some embodiments, the seed layer can also include a pure metal layer, such as Ti, Zr, Hf, Y, La, Zn, Co, Ru, Cr, Mo, W, V, Nb, Ta, and rare earth metals. In some embodiments, the seed layer includes mixtures or compounds of metallic elements, such as metal alloys, metal nitrides, or metal oxynitride.

In some embodiments, the present invention discloses an in-situ formation of a zinc oxide layer on a base layer without exposure to atmosphere. By controlling the surface of the base layer, for example, to reduce any possible surface contamination, the crystallization of zinc oxide layer can be further promoted and not impeded by any adhered particulates.

In some embodiments, the present base layer can provide improved zinc oxide layer with thinner film thickness. The crystallization of zinc oxide layer, and consequently its electrical conductivity, is not a function of film thickness, and thus can offer similar film quality at different thicknesses. The thickness of zinc oxide layer can be less 100 nm, such as less than 50 nm. The base layer can also be thin, preferably less than 50 nm.

In some embodiments, the present invention discloses methods to form base layer and zinc oxide layer, including thin film deposition methods such as physical vapor deposition (PVD), chemical vapor deposition (CVD), atomic layer deposition (ALD), or wet chemical deposition methods such as electroplating or electroless deposition.

In some embodiments, sputter systems, and methods to operate the sputter systems, are provided for making coated panels having a base layer serving as a template for a ZnO seed layer, which then serves as a template for a silver layer. In some embodiments, an in-line deposition system, including a transport mechanism for moving substrates between deposition stations is provided.

In some embodiments, methods for making low emissivity panels in large area coaters are disclosed. A transport mechanism can be provided to move a substrate under one or more sputter targets, to deposit a base layer before depositing a seed layer, an antireflective layer, together with other layers such as a surface protection layer.

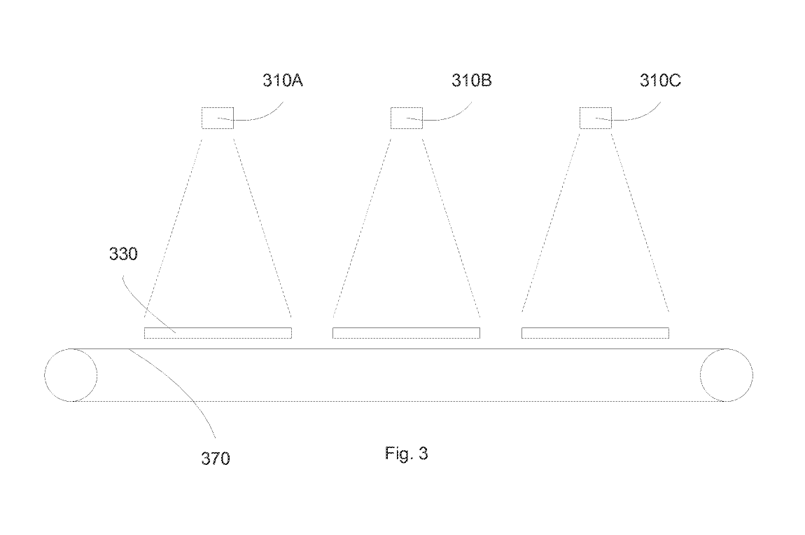

FIG. 3 illustrates an in-line deposition system according to some embodiments. A transport mechanism 370, such as a conveyor belt or a plurality of rollers, can transfer substrate 330 between different sputter deposition stations. For example, the substrate can be positioned at station #1, including a target assembly 310A, then transferred to station #2, including target assembly 310B, and then transferred to station #3, including target assembly 310C. Station #1 can be configured to deposited a base layer, for example, including an amorphous or nanocrystalline doped tin oxide with Al, Ga, In, Mg, Ca, Sr, Sb, Bi, Ti, V, Y, Zr, Nb, Hf, or Ta dopants. Station #2 can be configured to deposited a zinc oxide or a doped zinc oxide layer, which can include (002) crystal orientation. Station #2 can also be configured to deposit other seed layer materials, such as SnO₂, Sc₂O₃, Y₂O₃, TiO₂, ZrO₂, HfO₂, V₂O₅, Nb₂O₅, Ta₂O₅, CrO₃, WO₃, or MoO₃. Station #3 can be configured to deposit a silver layer, which can include (111) crystal orientation. Other configurations can be included, for example, station #2 can include multiple target assemblies for co-sputtering. In addition, other stations can be included, such as input and output stations, or anneal stations.

After depositing a first layer in station #1, for example, a base layer having Mg doped tin oxide for promoting (002) orientation in a seed layer, such as a zinc oxide layer, the substrate is moved to station #2, where a zinc oxide (or doped zinc oxide or other seed layer materials) layer can be deposited. The (002) crystal orientation of the deposited zinc oxide layer can be improved by the presence of the base layer. The substrate is then transferred to station #3 to deposit a silver layer over the zinc oxide layer. The (111) crystal orientation of the silver layer can be improved by the improved (002) orientation of the zinc oxide seed layer.

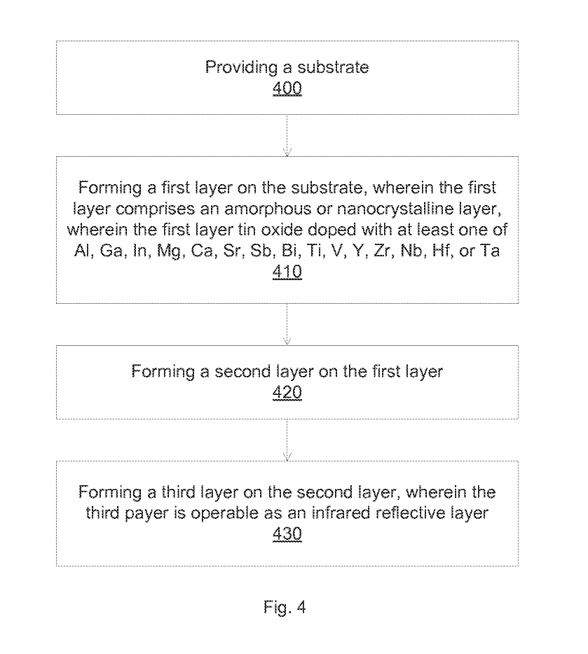

FIG. 4 illustrates a flow chart for sputtering coated layers according to some embodiments. In operation 400, a substrate is provided. The substrate can include a transparent substrate such as a glass substrate or any other transparent substrates, such as substrates made of organic polymers. In operation 410, a first layer is formed on the substrate. In some embodiments, the first layer includes an amorphous or nanocrystalline layer of doped tin oxide. The amorphous or nanocrystalline first layer can serve as a template for promoting a crystal orientation of a subsequent deposited layer.

In some embodiments, the first layer can be thin, for example, less than or equal to about 45 nm, less than or equal to about 20 nm, or less than or equal to about 10 nm.

In some embodiments, the amorphous or nanocrystalline characteristic of the first layer can be determined by x-ray diffraction. For example, if the X-ray diffraction pattern shows no discernible crystallinity peaks, the layer can be considered as an amorphous layer. If the X-ray diffraction pattern can indicate the presence of crystallinity peaks, but the crystallinity peaks can be too wide to allow determination of the crystal structure, the layer can be considered aa a nanocrystalline layer. Alternatively, an amorphous or nanocrystalline structure can be characterized as a polycrystalline material with a crystallite size between 0.5 nm to 5 nm.

In some embodiments, the dopants in the doped tin oxide of the first layer can include at least one of Al, Ga, In, Mg, Ca, Sr, Sb, Bi, Ti, V, Y, Zr, Nb, Hf, or Ta. The concentration of the doping element in doped tin oxide can be between 3 and 13 vol %.

In operation 420, a second layer is formed on the first layer. In some embodiments, the second layer can be operable as a seed layer for the subsequently deposited layer. Since the second layer is deposited on the first layer, the structure of the first layer, e.g., amorphous or nanocystalline doped tin oxide, can influence the crystal orientation of the second layer. For example, the first layer can allow a zinc oxide layer having improved (002) crystal orientation, as compared to a zinc oxide layer without the first layer.

In some embodiments, the second layer is formed on the first layer without being exposed to the ambient environment, e.g., ambient air. The control of the sequence deposition of the first and second layers can enhance the templating effect of the first layer on the second layer, improving the crystallinity of the second layer. In some embodiments, the second layer is less than or equal to about 100 nm. In some embodiments, the second layer is less than or equal to about 10 nm.

In some embodiments, the second layer can be operable as a seed layer for the third layer. The second layer can include at least one of ZnO, SnO₂, Sc₂O₃, Y₂O₃, TiO₂, ZrO₂, HfO₂, V₂O₅, Nb₂O₅, Ta₂O₅, CrO₃, WO₃, or MoO₃.

In operation 430, a third layer is deposited on the second layer. In some embodiments, the third layer includes silver. Since the third layer is deposited on the second layer, the crystal orientation of the second layer can influence the crystal orientation of the third layer. For example, the second zinc oxide layer having improved (002) crystal orientation can allow a silver layer having improved (111) crystal orientation, as compared to a silver layer deposited on a zinc oxide layer with less (002) crystal orientation.

In some embodiments, the third layer can be thin, for example, less than or equal to about 20 nm, or less than or equal to about 10 nm. The third layer can be formed in-situ on the second and/or first layer without exposing to ambient environment.

In some embodiments, the method can further include depositing an antireflective layer, or a barrier layer over the substrate. In some embodiments, an annealing step can be performed in an oxygen-containing ambient, for example, after forming the second layer. The annealing step can partially oxidize the first layer, forming an at least partially oxidized first layer.

In some embodiments, a photovoltaic device, a LED (light emitting diode) device, a LCD (liquid crystal display) structure, or an electrochromic layer is formed on the substrate having the layer structure.

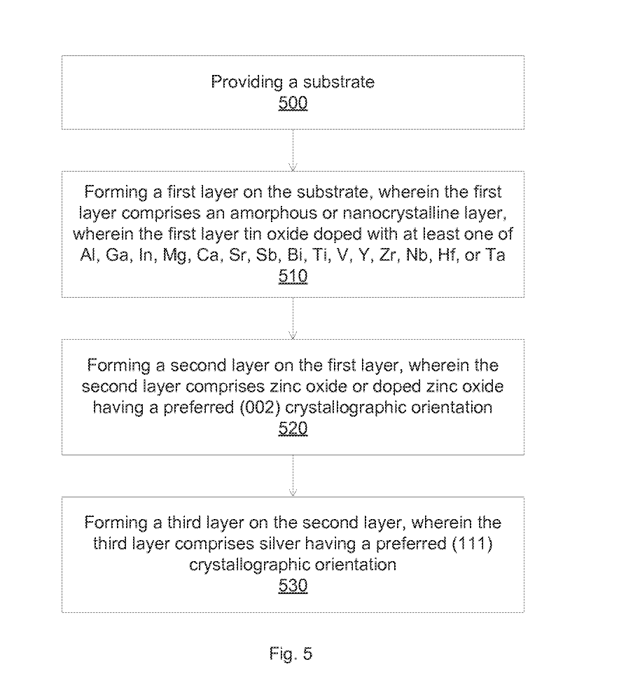

FIG. 5 illustrates a flow chart for sputtering coated layers according to some embodiments. In operation 500, a substrate is provided. In operation 510, a first layer is formed on the substrate. The first layer can include an amorphous or nanocrystalline doped tin oxide. In operation 520, a second layer is formed on the first layer, wherein the second layer includes zinc oxide or doped zinc oxide with a (002) preferred crystallographic orientation. In operation 530, a third layer is formed on the second layer, wherein the third layer includes silver having a (111) preferred crystallographic orientation.

In some embodiments, the first layer can be thin, for example, less than or equal to about 45 nm, less than or equal to about 20 nm, or less than or equal to about 10 nm.

In some embodiments, the amorphous or nanocrystalline characteristic of the first layer can be determined by x-ray diffraction. For example, if the X-ray diffraction pattern shows no discernible crystallinity peaks, the layer can be considered as an amorphous layer. If the X-ray diffraction pattern can indicate the presence of crystallinity peaks, but the crystallinity peaks can be too wide to allow determination of the crystal structure, the layer can be considered aa a nanocrystalline layer. Alternatively, an amorphous or nanocrystalline structure can be characterized as a polycrystalline material with a crystallite size between 0.5 nm to 5 nm.

In some embodiments, the dopants in the doped tin oxide of the first layer can include at least one of Al, Ga, In, Mg, Ca, Sr, Sb, Bi, Ti, V, Y, Zr, Nb, Hf, or Ta. The concentration of the doping element in doped tin oxide can be between 3 and 13 vol %.

In some embodiments, the second layer is formed on the first layer without being exposed to the ambient environment, e.g., ambient air. The control of the sequence deposition of the first and second layers can enhance the templating effect of the first layer on the second layer, improving the crystallinity of the second layer. In some embodiments, the second layer is less than or equal to about 100 nm. In some embodiments, the second layer is less than or equal to about 10 nm.

In some embodiments, the third layer can be thin, for example, less than or equal to about 20 nm, or less than or equal to about 10 nm. The third layer can be formed in-situ on the second and/or first layer without exposing to ambient environment.

In some embodiments, the method can further include depositing an antireflective layer, or a barrier layer over the substrate. In some embodiments, an annealing step can be performed in an oxygen-containing ambient, for example, after forming the second layer. The annealing step can partially oxidize the first layer, forming an at least partially oxidized first layer.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A method to form a low emissivity coating, comprising
providing a substrate;
forming a first layer on the substrate, wherein the first layer comprises an amorphous or a nanocrystalline layer, wherein the first layer comprises tin oxide doped with at least one of Al, Ga, In, Mg, Ca, Sr, Sb, Bi, Ti, V, Y, Zr, Nb, Hf, or Ta;
forming a second layer on the first layer;
forming a third layer on the second layer, wherein the third layer is operable as an infrared reflective layer, wherein the second layer comprises a seed material configured to promote a preferred crystallographic orientation of the third layer.

2. The method of claim 1, wherein the substrate comprises a glass substrate.

3. A method as in claim 1, wherein the first layer comprises a polycrystalline material with a crystallite size between 0.5 nm to 5 nm.

4. A method as in claim 1, wherein the first layer comprises an amorphous material.

5. A method as in claim 1, wherein the concentration of the doping element in doped tin oxide is between 3 and 13 vol %.

6. A method as in claim 1, wherein the thickness of the first layer is less than 45 nm.

7. A method as in claim 1, wherein the second layer comprises at least one of ZnO, SnO₂, Sc₂O₃, Y₂O₃, TiO₂, ZrO₂, HfO₂, V₂O₅, Nb₂O₅, Ta₂O₅, CrO₃, WO₃, or MoO₃.

8. A method to form a low emissivity coating, comprising
providing a substrate;
forming a first layer on the substrate, wherein the first layer comprises an amorphous or a nanocrystalline layer, wherein the first layer comprises tin oxide doped with at least one of Al, Ga, In, Mg, Ca, Sr, Sb, Bi, Ti, V, Y, Zr, Nb, Hf, or Ta;
forming a second layer on the first layer, wherein the second layer comprises zinc oxide or doped zinc oxide having a preferred (002) crystallographic orientation;
forming a third layer on the second layer, wherein the third layer comprises silver having a preferred (111) crystallographic orientation.

9. A method as in claim 8, wherein the first layer comprises a polycrystalline material with a crystallite size between 0.5 nm to 5 nm.

10. A method as in claim 8, wherein the first layer comprises an amorphous material.

11. A method as in claim 8, wherein the concentration of the doping element in doped tin oxide is between 3 and 13 vol %.

12. A method as in claim 8, wherein the thickness of the first layer is less than 45 nm.

13. A method as in claim 8, further comprising
depositing a fourth layer over the transparent substrate,
wherein the fourth layer is operable as an antireflective layer.

14. A method as in claim 8 further comprising
depositing a fifth over the third layer,
wherein the fifth layer is operable as a barrier layer.

15. The method of claim 8, wherein the second layer is formed in-situ on the first layer without exposing to ambient environment.

16. A low emissivity panel, comprising
a substrate;
a first layer disposed on the substrate, wherein the first layer comprises an amorphous or a nanocrystalline layer, wherein the first layer comprises tin oxide doped with at least one of Al, Ga, In, Mg, Ca, Sr, Sb, Bi, Ti, V, Y, Zr, Nb, Hf, or Ta;
a second layer disposed on the first layer, wherein the second layer comprises zinc oxide or doped zinc oxide having a preferred (002) crystallographic orientation;
a third layer disposed on the second layer, wherein the third layer comprises silver having a preferred (111) crystallographic orientation.

17. The low emissivity panel of claim 16 wherein the substrate comprises a glass substrate.

18. A low emissivity panel as in claim 16, wherein the first layer comprises a polycrystalline material with a crystallite size between 0.5 nm to 5 nm.

19. A low emissivity panel as in claim 16, wherein the first layer comprises an amorphous material.

20. A low emissivity panel as in claim 16 wherein the concentration of the doping element in doped tin oxide is between 3 and 13 vol %.
